(19) United States
(12) Patent Application Publication
(10) Pub. No.: US 2026/0127130 A1
(43) Pub. Date: May 7, 2026

(54) DISABLED PORT SUPPORT SYSTEM

(71) Applicant: Dell Products L.P., Round Rock, TX (US)

(72) Inventors: Wei Liu, Austin, TX (US); Po-Yu Cheng, Tainan City (TW)

(21) Appl. No.: 18/938,382

(22) Filed: Nov. 6, 2024

(51) Int. Cl. G06F 13/42

(52) U.S. Cl. CPC G06F 13/4282; G06F 2213/0042

(57) ABSTRACT

A disabled port support system includes a computing device including a port. A port management subsystem in the computing device is coupled to the port. During initialization of the computing device, the port management subsystem determines that the port is configured to be disabled to provide a disabled port. When the port management subsystem detects that a human interface device has been connected to the disabled port, it enables a disabled port support protocol for the human interface device that is connected to the disabled port. The port management subsystem may then use the disabled port support protocol to detect if an input signal has been generated by the human interface device that is connected to the disabled port and, if so, provide a disabled port support alert.

### BACKGROUND

The present disclosure relates generally to information handling systems, and more particularly to providing support for information handling systems that have had one or more of their ports disabled.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, servers, switches, and/or other computing devices known in the art, include ports (e.g., Universal Serial Bus (USB) ports) that may be used to connect devices (e.g., USB devices) to the computing device. In some situations, the security of such computing devices may be enhanced by disabling ports on that computing device, which can raise some issues.

To provide a specific example, servers available from DELL® Inc. of Round Rock, Texas, United States provide four Basic Input/Output System (BIOS) port setup options in their BIOS for “user-accessible” USB ports included on the server (e.g., USB ports that are accessible to a user via an outer surface of that server). Those four BIOS port setup options include 1) an “all ports on” BIOS port setup option in which all of the user-accessible USB ports on the server are enabled, 2) an “only back ports on” BIOS port setup option in which only the user-accessible USB ports on the “back” of the server (e.g., user-accessible USB ports on a back surface of the server that one of skill in the art in possession of the present disclosure will appreciate are relatively inaccessible when that server is positioned in a rack) are enabled while the user-accessible USB ports on the “front” of the server (e.g., user-accessible USB ports on a front surface of the server that one of skill in the art in possession of the present disclosure will appreciate are relatively accessible when that server is positioned in a rack as compared to the user-accessible USB ports on the back surface of that server) are disabled, and 3) an “all ports off” BIOS port setup option in which all of the user-accessible USB ports on the server are disabled.

When any of the “all ports on”, “only back ports on”, or “all ports off” BIOS port setup options described above are enabled, a Baseboard Management Controller (BMC) in the server has no independent control over the user-accessible USB ports on the “front” of the server that would allow that BIOS port setup option for those user-accessible USB ports to be modified during runtime of the server. As such, the four BIOS port setup options discussed above also include an “all ports off (dynamic)” BIOS port setup option in which all of the user-accessible USB ports on the server are disabled, and the BMC in the server has independent control over the user-accessible USB ports on the “front” of the server that allows the “all ports off (dynamic)” BIOS port setup option for those user-accessible USB ports to be modified during runtime of the server (e.g., via a settings in a BMC Graphical User Interface (GUI), Remote Access Controller ADMinistrator (RACADM) commands, etc.), which is often used to temporarily enable those user-accessible USB ports during runtime of the server in order to perform trouble shooting.

However, when the “all ports off” BIOS port setup option or the “all ports off (dynamic)” BIOS port setup option described above are enabled, USB keyboard devices and USB mouse devices that are connected to user-accessible USB ports on the server during initialization of the server are allowed to operate to ensure that a user can access the BIOS (e.g., by selecting an “F2” key on the USB keyboard device during the initialization of the server) and modify the BIOS port setup option if desired in order to enable the disabled ports, while other classes of USB devices (e.g., other than USB hub devices) connected to the user-accessible USB ports on the server will not be allowed to operate. The user-accessible USB ports to which a USB keyboard device or USB mouse device is connected will then be disabled immediately before providing an operating system on that server or providing a Unified Extensible Firmware Interface (UEFI) shell on the that server so that no USB devices connected to the user-accessible USB ports on the server are allowed to operate during runtime of the server.

While the USB port disablement functionality described above provides sufficient security in most situations, there are some situations (e.g., telecommunications (Telco) situations, “edge” device situations, public deployment situations with unknown security, etc.) in which an enhanced level of security is desired by disabling the user-accessible USB ports on the server “completely” such that a USB keyboard device or USB mouse device connected to those user-accessible USB ports will not be allowed to operate during the initialization of the server as described above.

However, such enhanced security for servers (i.e., disabling user-accessible USB ports and preventing operation of USB keyboard devices and USB mouse devices connected thereto during initialization of the server) presents substantial obstacles to a user that wishes to enable user-accessible USB ports that have been disabled on that server. For example, the inventors of the present disclosure have recognized that when servers are configured with the enhanced security described above, most users will typically connect a USB keyboard device to a user-accessible port on the server and attempt to use that USB keyboard device to enable user-accessible USB ports that have been disabled on that server, but will simply be unable to do so as that USB keyboard device will not be allowed to operate and any input to that USB keyboard device will result in no feedback to the user. As will be appreciated by one of skill in the art in possession of the present disclosure, situations like those described above result in customer support calls and the expenditure of resources in order to address them.

Accordingly, it would be desirable to provide a disabled port support system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a port management engine that is configured, during Information Handling System (IHS) initialization operations, to: determine that a port that is coupled to the processing system is configured to be disabled to provide a disabled port; detect that a human interface device has been connected to the disabled port; enable a disabled port support protocol for the human interface device that is connected to the disabled port; detect, using the disabled port support protocol, an input signal generated by the human interface device that is connected to the disabled port; and provide, in response to detecting the input signal generated by the human interface device that is connected to the disabled port using the disabled port support protocol, a disabled port support alert.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may provide the disabled port support system of the present disclosure.

FIG. 3 is a flow chart illustrating an embodiment of a method for providing disabled port support.

FIG. 4 is a schematic view illustrating an embodiment of the computing device of FIG. 2 operating during the method of FIG. 3.

FIG. 5 is a schematic view illustrating an embodiment of the computing device of FIG. 2 operating during the method of FIG. 3.

FIG. 6 is a schematic view illustrating an embodiment of the computing device of FIG. 2 operating during the method of FIG. 3.

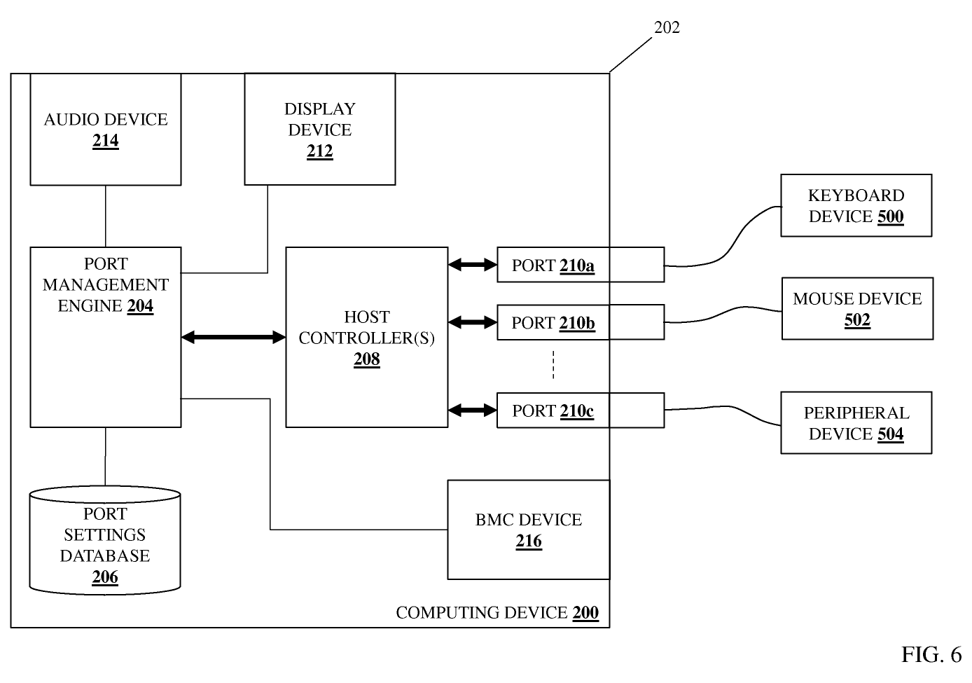

FIG. 7 is a schematic view illustrating an embodiment of the computing device of FIG. 2 operating during the method of FIG. 3.

FIG. 8 is a schematic view illustrating an embodiment of the computing device of FIG. 2 operating during the method of FIG. 3.

FIG. 9A is a schematic view illustrating an embodiment of the computing device of FIG. 2 operating during the method of FIG. 3.

FIG. 9B is a schematic view illustrating an embodiment of a display device on the computing device of FIG. 2 displaying a disabled port support alert message during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

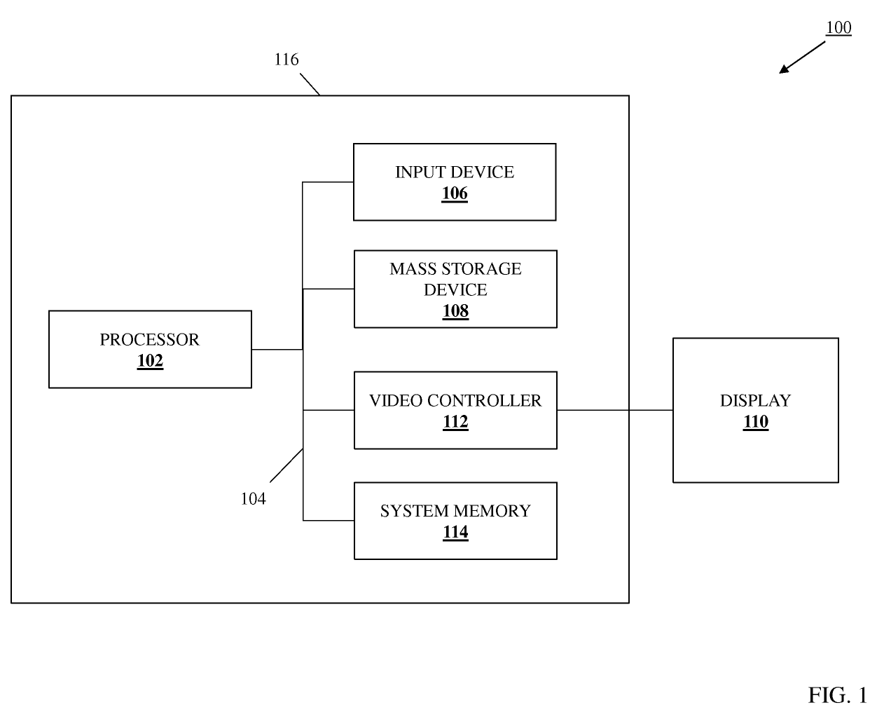

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

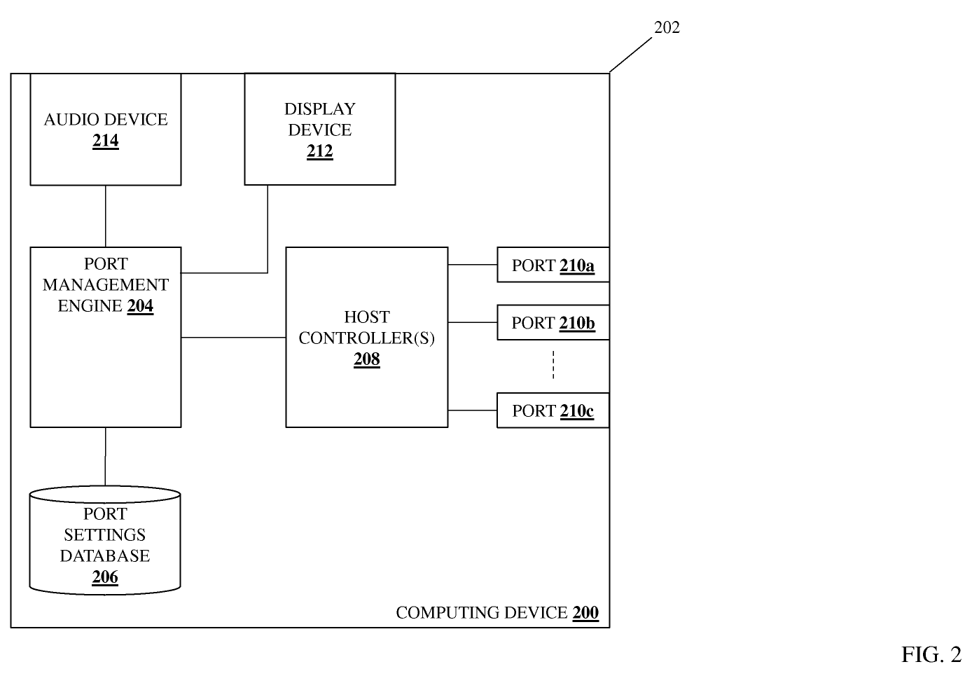

Referring now to FIG. 2, an embodiment of a computing device 200 is illustrated that may provide the disabled port support system of the present disclosure. In an embodiment, the computing device 200 may be provided by the IHS 100 discussed above with reference to FIG. 1 and/or may include some or all of the components of the IHS 100, and in specific examples may be provided by a server device. Furthermore, while illustrated and discussed as being provided by a server device, one of skill in the art in possession of the present disclosure will recognize that the functionality of the computing device 200 discussed below may be provided by networking devices (e.g., switch devices), storage systems, and/or other computing devices that are configured to operate similarly as the computing device 200 illustrated and discussed below.

In the illustrated embodiment, the computing device 200 includes a chassis 202 that houses the components of the computing device 200, only some of which are illustrated and described below. For example, the chassis 202 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a port management engine 204 that is configured to perform the functionality of the port management engines, port management subsystems, and/or computing devices discussed below.

To provide a specific example, the processing system may be provided by Basic Input/Output System (BIOS) processing firmware, and the memory system may be provided by BIOS memory firmware that includes instructions that, when executed by the BIOS processing firmware, cause the BIOS processing firmware to provide a BIOS that provides the port management engine 204 and that is configured to perform hardware initialization for the computing device 200, runtime services for an operating system and/or applications running on the computing device 200, and/or other BIOS operations known in the art in addition to the disabled port support functionality described below. However, while a specific implementation of the port management engine 204 has been described, one of skill in the art in possession of the present disclosure will appreciate how the port management engine 204 may be provided in a variety of manners that will fall within the scope of the present disclosure as well.

The chassis 202 may also house a storage system (not illustrated, but which may include the storage 108 discussed above with reference to FIG. 1) that is coupled to the port management engine 204 (e.g., via a coupling between the storage system and the processing system) and that includes a port settings database 206 that is configured to store any of the information utilized by the port management engine 204 discussed below. Continuing with the specific example above in which the port management engine 204 is provided by a BIOS, the port settings database 206 may store BIOS settings for that BIOS, and thus may include the port settings described below, as well as any other BIOS settings that would be apparent to one of skill in the art in possession of the present disclosure.

In the illustrated embodiment, the chassis 202 includes one or more host controllers 208 that are coupled to the port management engine 204 (e.g., via a coupling between the host controller(s) 208 and the processing system). In the specific examples provided below, the host controller(s) 208 are provided by Universal Serial Bus (USB) host controller(s) (e.g., an xHCI USB host controller for USB 3.0, an eHCI USB host controller for USB 2.0, an oHCI USB host controller for USB 1.1, etc.), but one of skill in the art in possession of the present disclosure will appreciate how other host controllers will fall within the scope of the present disclosure as well. As illustrated, a plurality of ports 210a, 210b, and up to 210c are coupled to port management engine 204 via the host controller(s) 208. In the specific examples provided below, the ports 210a-210b are provided by USB ports that may be provided on a “front” of the computing device 200 (e.g., a front surface of the computing device 200 that one of skill in the art in possession of the present disclosure will appreciate makes those USB ports relatively accessible when the computing device 200 is positioned in a rack) and a “back” of the computing device 200 (e.g., a back surface of the computing device 200 that is opposite the front surface and that one of skill in the art in possession of the present disclosure will appreciate makes those USB ports relatively inaccessible when the computing device 200 is positioned in a rack), although one of skill in the art in possession of the present disclosure will recognize that other types of ports and/or ports provided anywhere on the computing device 200 will fall within the scope of the present disclosure as well.

In the embodiment illustrated and described below, the chassis 202 includes a display device 212 that is coupled to the port management engine 204 (e.g., via a coupling between the display device 212 and the processing system) and that is configured to display the images, messages, and/or other data described below. However, while the display device 212 is illustrated and described as being provided by an integrated display device in the computing device 200 (e.g., e.g., a display device on a laptop/notebook computer that provides the computing device 200), one of skill in the art in possession of the present disclosure will appreciate how the display device 212 may be connected to the computing device 200 (e.g., e.g., an external display device connected to a desktop computer that provides the computing device 200) while remaining within the scope of the present disclosure as well.

In the embodiment illustrated and described below, the chassis 202 also includes an audio device 214 that is coupled to the port management engine 204 (e.g., via a coupling between the audio device 214 and the processing system) and that may include audio drivers, speakers, and/or other audio components that one of skill in the art in possession of the present disclosure will recognize are configured to produce the audio described below. Furthermore, the chassis 202 may also include a Baseboard Management Controller (BMC) device 216 that is coupled to the port management engine 204 (e.g., via a coupling between the BMC device 216 and the processing system) and that may be provided by an integrated DELL® Remote Access Controller (iDRAC) device included in server devices available from DELL® Inc. of Round Rock, Texas, United States; an OpenBMC device provided according to OpenBMC specifications, and/or other BMC devices that would be apparent to one of skill in the art in possession of the present disclosure.

As will be appreciated by one of skill in the art in possession of the present disclosure, the BMC device 216 may be configured to provide Out-Of-Band (OOB) management and monitoring for hardware in the computing device using resources that are mostly separate from the computing device 200 and via a browser-based interface or Command Line Interface (CLI). As such, the BMC device 216 may include virtual media devices, virtual Keyboard, Video, Mouse (KVM) devices, and/or other BMC components that are connected to BMC-dedicated ports on the computing device 200 that are always enabled to allow the OOB management and monitoring described above.

However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the disabled port support functionality discussed below, while remaining within the scope of the present disclosure as well

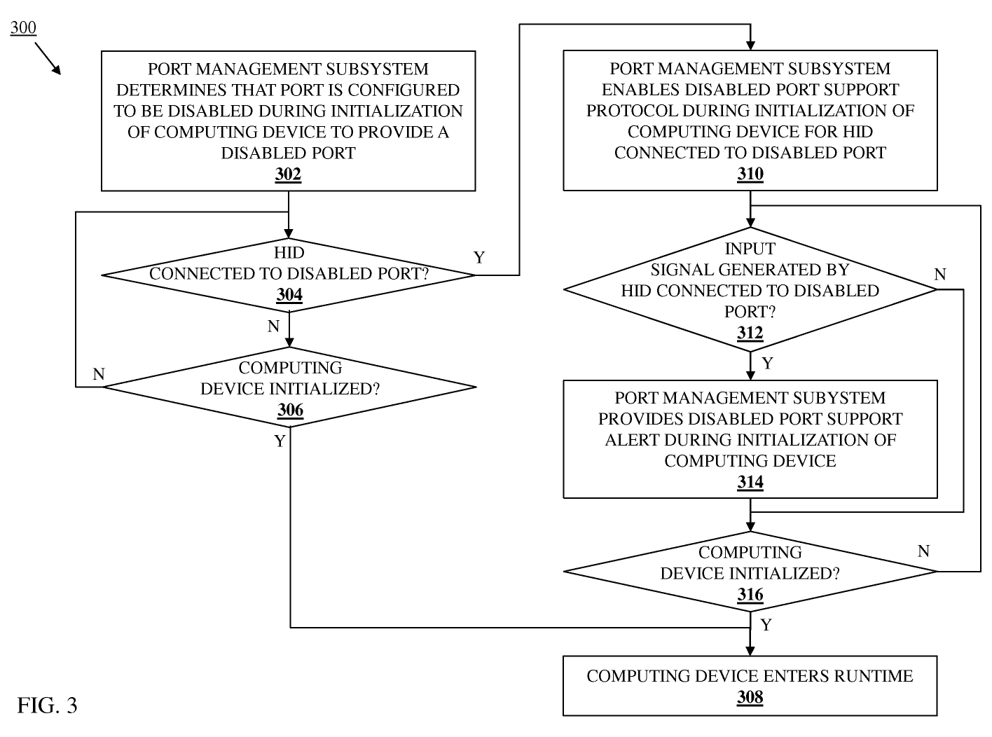

Referring now to FIG. 3, an embodiment of a method 300 for providing disabled port support is illustrated. As discussed below, the systems and methods of the present disclosure enable a disabled port support protocol when a human interface device is connected to a disabled port during computing device initialization in order to provide for the detection of an input signal from that human interface device so that a disabled port support alert may be provided. For example, the disabled port support system of the present disclosure may include a computing device including a port. A port management subsystem in the computing device is coupled to the port. During initialization of the computing device, the port management subsystem determines that the port is configured to be disabled to provide a disabled port. When the port management subsystem detects that a human interface device has been connected to the disabled port, it enables a disabled port support protocol for the human interface device that is connected to the disabled port. The port management subsystem may then use the disabled port support protocol to detect if an input signal has been generated by the human interface device that is connected to the disabled port and, if so, provide a disabled port support alert. As discussed below, a user wishing to enabled ports that have been disabled on a computing device may connect a human interface device to that computing device and use it to provide an input signal that results in a disabled port support alert message, disabled port support alert audio, and or other disabled port support alerts that would be apparent to one of skill in the art in possession of the present disclosure, thus reducing customer support calls related to inabilities to enable disabled ports and the expenditure of resources in order to address them.

The method 300 begins at block 302 where a port management subsystem determines that a port is configured to be disabled during initialization of a computing device to provide a disabled port. In an embodiment, during or prior to the method 300, a network administrator or other user may configure one or more of the ports 210a-210c on the computing device 200 to be disabled by providing one or more disabled port settings in the port settings database 206. In a specific example, the network administrator or other user may provide BIOS settings (e.g., in the port settings database 206) for the BIOS that provides the port management engine 204, and one of skill in the art in possession of the present disclosure will appreciate those BIOS settings may be configured to cause the BIOS to disable one or more of the ports 210a-210c on the computing device 200 during any initialization of the computing device 200, with specific examples of those BIOS settings providing for the enabling any of the “only back ports on”, “all ports off”, or “all ports off (dynamic)” BIOS port setup options described above.

As such, while all of the ports 210a-210c are configured to be disabled in the specific examples provided below, one of skill in the art in possession of the present disclosure will appreciate how any subset of the ports 210a-210c may be configured to be disabled while remaining within the scope of the present disclosure as well. Furthermore, while several specific techniques for disabling ports have been described, one of skill in the art in possession of the present disclosure will appreciate how ports on a computing device may be disabled using a variety of techniques that will fall within the scope of the present disclosure as well.

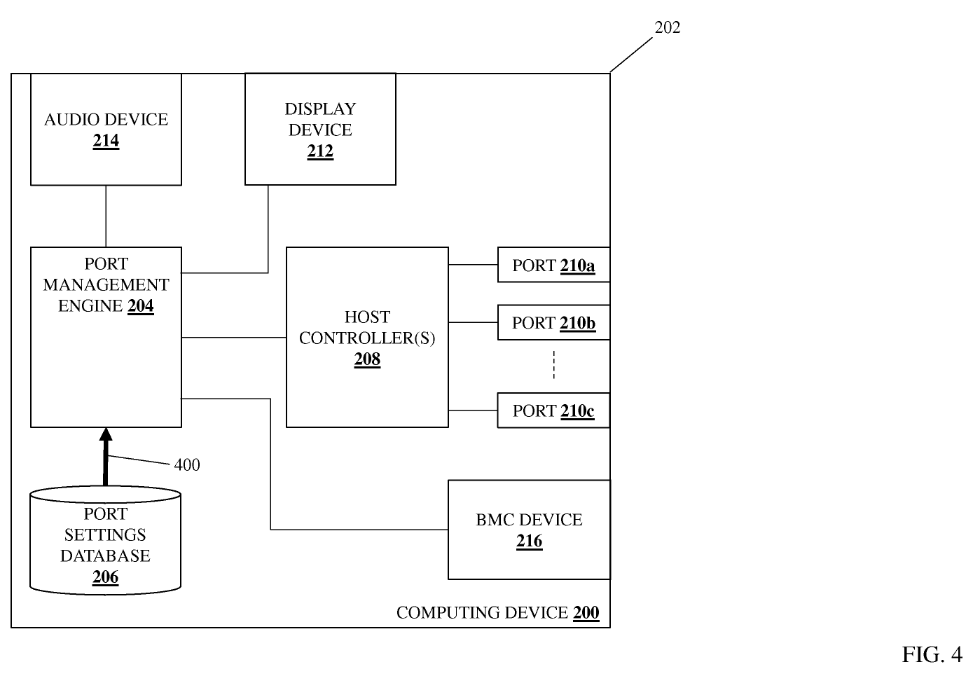

With reference to FIG. 4, in an embodiment of block 302, the computing device 200 may be powered on, booted, reset, rebooted, and/or otherwise initialized and, in response, the port management engine 204 may perform port disablement identification operations 400 that include accessing the port settings database 206 and identifying the disabled port settings that are included therein and that are configured to disable the port(s) 210a-210c as described above (e.g., during initialization of the computing device 200, the BIOS that provides the port management engine 204 may identify the BIOS settings in the port settings database 206 that are configured to disable the port(s) 210a-210c).

As will be appreciated by one of skill in the art in possession of the present disclosure, the computing device initialization portions of the method 300 described below may be performed during the Boot Device Selection (BDS) phase of the boot/initialization of the computing device 200 that follows the Direct eXecution Environment (DXE) phase, although the performance of the computing device initialization portions of the method 300 during other times will fall within the scope of the present disclosure as well. Furthermore, while specific techniques for identifying ports that are configured to be disabled have been described, one of skill in the art in possession of the present disclosure will appreciate how port disablement configurations for ports on a computing device may be identified using a variety of techniques that will fall within the scope of the present disclosure as well.

In an embodiment, the initialization of the computing device 200 may include enabling the host controller(s) 208. As will be appreciated by one of skill in the art in possession of the present disclosure, while the ports 210a-210c may be easily disabled by disabling (or not enabling) the host controller(s) 208, disabling the ports 210a-210c in such a manner may prevent the re-enabling of those ports via the BMC device 216 as described in further detail below, As such, in response to determining that a port is configured to be disabled, the port management engine 204 will consider that port to be a “disabled port” and, in response, will not install protocols that would otherwise allow devices connected to that port to operate (if installed), and thus the determination that any port is configured to be disabled causes that port to become a “disabled port” for the purposes of the discussion below. However, while specific techniques for disabling ports are described herein, other techniques for disabling ports (e.g., disabling the host controller(s) 208, configuring multiplexers, configuring switches, etc.) may fall within the scope of the present disclosure as well.

The method 300 then proceeds to decision block 304 where the method 300 proceeds depending on whether a Human Interface Device (HID) is connected to the disabled port. As discussed below, HIDs such as keyboard devices, mouse devices, and/or other human interface devices known in the art may be connected to the ports 210a-210c on the computing device 200 that have been disabled, and the port management engine 204 may be configured to determine when a device connected to a disabled port is an HID. As such, at decision block 304, the port management engine 204 may monitor for the connection of an HID to a disabled port during the initialization of the computing device 200.

If, at decision block 304, an HID is not connected to the disabled port, the method 300 proceeds to decision block 306 where the method 300 proceeds depending on whether the computing device is initialized. As will be appreciated by one of skill in the art in possession of the present disclosure, the initialization of the computing device 200 (e.g., by the BIOS) may continue while the port management engine 204 monitors for the connection of an HID to a disabled port, and will eventually complete such that an operating system is loaded on the computing device 200 and the computing device 200 enters runtime as described below. If, at decision block 306, the computing device is not initialized, the method 300 returns to decision block 304. As such, the method 300 may loop such that the port management engine 204 continues to monitor for the connection of an HID to a disabled port until the initialization of the computing device 200 is completed.

If, at decision block 306, the computing device is initialized, the method 300 proceeds to block 308 where the computing device enters runtime. In an embodiment, at block 308 and as described above, the completion of the initialization of the computing device 200 (e.g. by the BIOS) may result in the loading of an operating system on the computing device 200 and the computing device 200 entering runtime, and one of skill in the art in possession of the present disclosure will appreciate how any ports that were disabled during the initialization of the computing device 200 may remain disabled during runtime of the computing device 200.

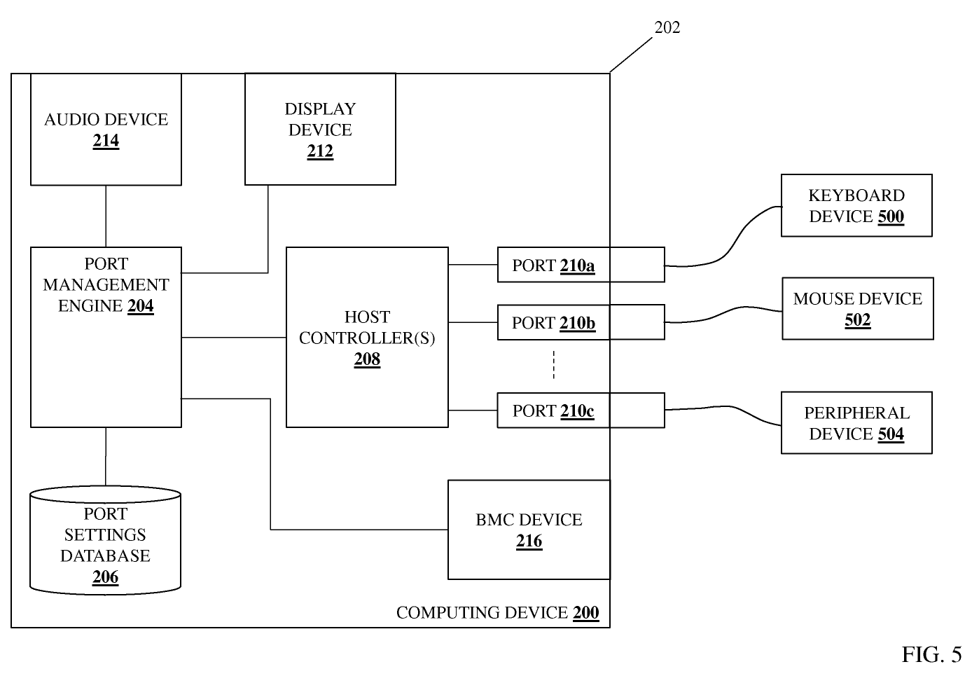

If, at decision block 304, a HID is detected as having been connected to a disabled port, the method 300 proceeds to block 310 where the port management subsystem enables a disabled port support protocol during the initialization of the computing device for the HID connected to the disabled port. With reference to FIG. 5, in an embodiment of decision block 304, a plurality of HID devices, which are provided by a keyboard device 500 and a mouse device 502 in the illustrated embodiment, are connected to the ports 210a and 210b, while a peripheral device 504, which is provided by a storage device in the illustrated embodiment, is connected to the port 210c. In the specific examples provided below, the keyboard device 500 is a USB keyboard device, the mouse device 502 is a USB mouse device, and the peripheral device 504 is a USB storage device (e.g., a USB “thumb drive”), but one of skill in the art in possession of the present disclosure will appreciate how different types and numbers of devices may be connected to the ports 210a-210c while remaining within the scope of the present disclosure as well.

As will be appreciated by one of skill in the art in possession of the present disclosure, following the connection of the keyboard device 500, the mouse device 502, and the peripheral device 504 to the ports 210a, 210b, and 210c, respectively, the port management engine 204 may retrieve device identification information via the host controller(s) 208 for each of the keyboard device 500, the mouse device 502, and the peripheral device 504. To provide a specific example, during the initialization of the computing device 200, a PCIe host bridge DXE driver may enumerate a PCIe host bridge and output a PCI I/O protocol that is configured to cause DXE drivers for the host controller(s) 208 (e.g., an xHCI DXE driver, an eHCI DXE driver, an oHCI DXE driver, etc.) to output a UEFI standard host controller protocol (e.g., a “USB2HC” protocol) that causes a bus between the host controller(s) 208 and the ports 210a-210c to output an I/O protocol that allows the communications discussed below with the devices connected thereto.

Continuing with the example in which the keyboard device 500, the mouse device 502, and the peripheral device 504 are USB devices, each of the keyboard device 500, the mouse device 502, and the peripheral device 504 may report their respective USB class via the host controller(s) 208 to the port management engine 204 (e.g. via the communications using a USB I/O protocol as discussed above), which one of skill in the art in possession of the present disclosure will appreciate will result in the keyboard device 500 and the mouse device 502 reporting a USB HID class, and the peripheral device 504 reporting a USB mass storage device class when the peripheral device 504 is provided by a USB storage device (or some other non-HID class when the peripheral device 504 is not an HID for the purposes of the embodiments described below).

As will be appreciated by one of skill in the art in possession of the present disclosure, when the peripheral device 504 is connected to the port 210c that has been disabled as described above, the port management engine 204 will not install any protocols that would allow that peripheral device 504 (i.e., a non-HID as described above) to operate with the computing device 200. However, while a specific example has been provided, one of skill in the art in possession of the present disclosure will appreciate how non-HIDs may be prevented from operating when connected to disabled ports using a variety of techniques that will fall within the scope of the present disclosure as well.

As will also be appreciated by one of skill in the art in possession of the present disclosure and as discussed above, conventional port disabling systems like those described above will install protocols to allow operation of HIDs when those HIDs are connected to disabled ports during the initialization of computing devices in order to allow those HIDs to operate with the computing device during its initialization and be used by a user if they wish to enable those ports. For example, in such conventional port disabling systems, when a keyboard device is connected to a disabled port during computing device boot/initialization, a simple text output protocol (e.g., “EFI_SIMPLE_TEXT_OUTPUT_PROTOCOL”) and a simple text input protocol (e.g., “EFI_SIMPLE_TEXT_INPUT_EX_PROTOCOL”) may be installed to allow that keyboard device to operate. Similarly, in such conventional port disabling systems, when a mouse device is connected to a disabled port during computing device boot/initialization, a simple pointer protocol (e.g., “EFI_SIMPLE_POINTER_PROTOCOL”) and an absolute pointer protocol (e.g., “EFI_ABSOLUTE_POINTER_PROTOCOL”) may be installed to allow that mouse device to operate.

However, in the disabled port support system of the present disclosure, the port management engine 204 will not install the simple text output protocol (e.g., “EFI_SIMPLE_TEXT_OUTPUT_PROTOCOL”) and the simple text input protocol (e.g., “EFI_SIMPLE_TEXT_INPUT_EX_PROTOCOL”) for the keyboard device 500 when it is connected to the port 210a during computing device boot/initialization at decision block 304, and will not install the simple pointer protocol (e.g., “EFI_SIMPLE_POINTER_PROTOCOL”) and the absolute pointer protocol (e.g., “EFI_ABSOLUTE_POINTER_PROTOCOL”) for the mouse device 502 when it is connected to the port 210b during computing device boot/initialization at decision block 304, which one of skill in the art in possession of the present disclosure will appreciate will substantially prevent the keyboard device 500 and the mouse device 502 from operating with the computing device 200 (i.e., except as described below via the disabled port support protocol).

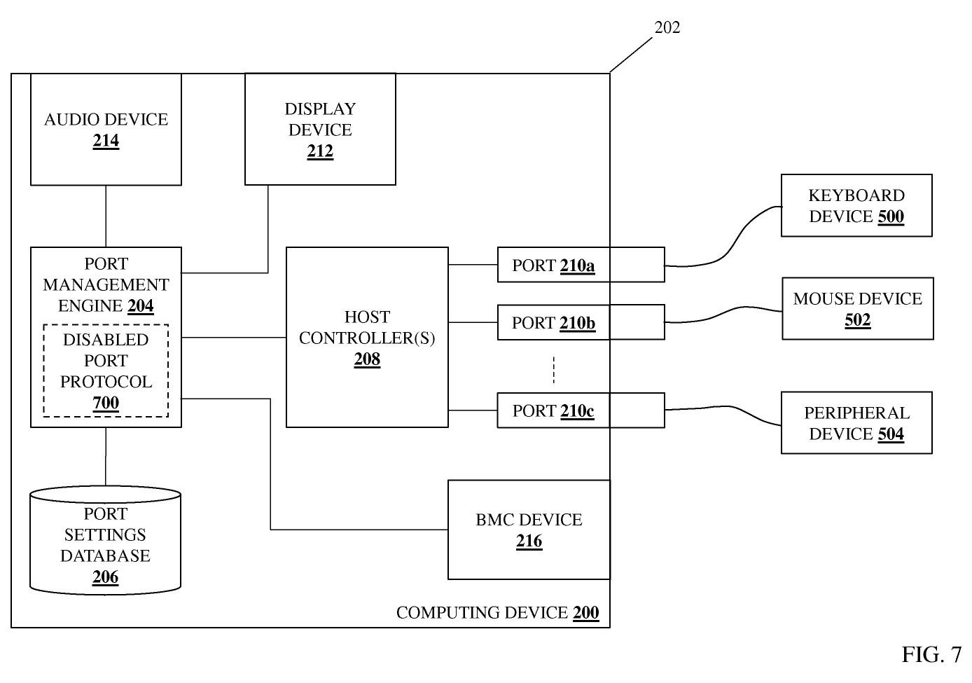

Rather, with reference to FIG. 7, at block 310 the port management engine 204 may publish, install, and/or otherwise enable a disabled port protocol 700 for the keyboard device 500 connected to the port 210a () and for the mouse device 502 connected to the port 210b (e.g., the disabled port protocol 700 may be installed on the corresponding USB I/O for the keyboard device 500 and mouse device 502 in a manner that one of skill in the art in possession of the present disclosure would recognize allows for the input signal detection on the disabled ports and the corresponding disabled port alert provisioning described below. As described herein, the disabled port protocol is configured for use by the port management engine 204 to detect input signals from the keyboard device 500 and/or the mouse device 502 and, in response, provide the disabled port support alerts described below. In other words, the disabled port protocol 700 enable the port management engine 204 to detect input signals from HIDs and provide the disabled port support alert(s) described below while those HIDs are substantially prevented from operating with the computing device 200 (i.e., the only operation of the HIDs with the computing device 200 may be associated with the ability of the port management engine 204 to detect input signals from those HIDs). However, while specific disabled port support protocol functionality has been described, one of skill in the art in possession of the present disclosure will appreciate how the disabled port support functionality described below may be provided in a variety of manners that will enable the provisioning of the disabled port support alerts discussed in further detail below.

The method 300 then proceeds to decision block 312 where the method 300 proceeds depending on whether an input signal is generated by the HID connected to the disabled port. As will be appreciated by one of skill in the art in possession of the present disclosure, a user of the keyboard device 500 may generate an input signal by selecting a key on the keyboard device 500, and/or performing any other keyboard input signal generation actions known in the art. Similarly, one of skill in the art in possession of the present disclosure will recognize how a user of the mouse device 502 may generate an input signal by moving the mouse device 502, selecting a button (e.g., “clicking”) the mouse device 502, and/or performing any other mouse input signal generation actions known in the art. Furthermore, while specific examples have been provided, one of skill in the art in possession of the present disclosure will appreciate how the generation of any HID input signals will fall within the scope of the present disclosure. As such, at decision block 312, the port management engine 204 may use the disabled port protocol 700 to monitor for input signals from the keyboard device 500 and the mouse device 502.

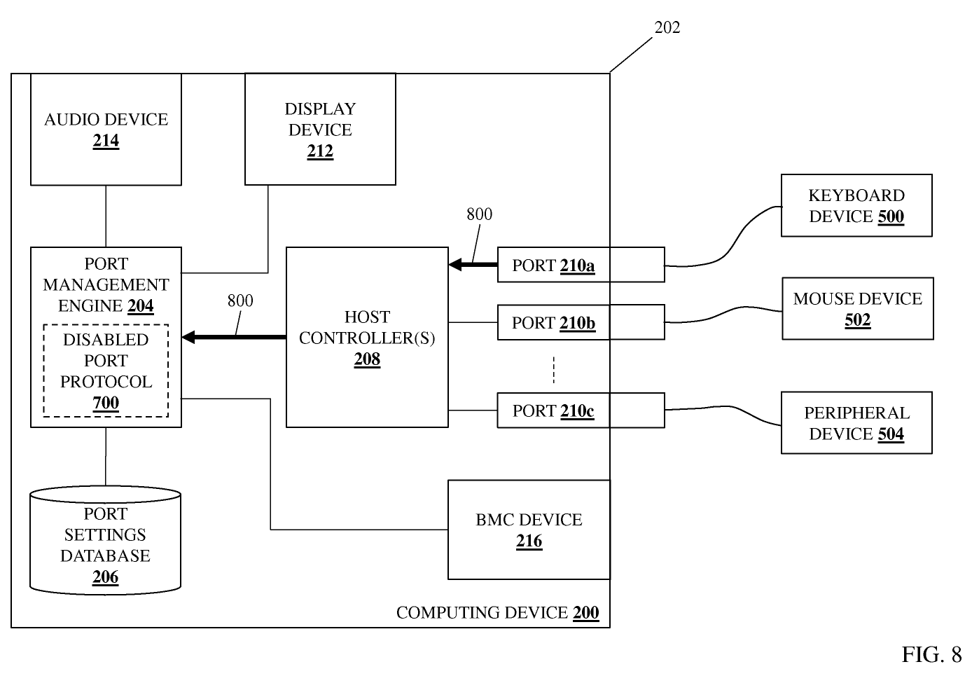

If, at decision block 312, an input signal is generated by the HID connected to the disabled port, the method 300 proceeds to block 314 where the port management subsystem provides a disabled port support alert during the initialization of the computing device. With reference to FIG. 8, in an embodiment of decision block 312, the keyboard device 500 may perform input signal provisioning operations 800 that may include generating an input signal (e.g., in response to a user selecting a key on the keyboard device 500 and/or performing any other keyboard input signal generation actions known in the art) that is detected by the port management engine 204 using the disabled port protocol 700 and via the host controller(s) 208 and the port 210a. Furthermore, while not illustrated or described herein in detail, one of skill in the art in possession of the present disclosure will appreciate how at block 314 the mouse device 502 may perform similar input signal provisioning operations that may include generating an input signal (e.g., in response to a user moving the mouse device 502, selecting a button (e.g., “clicking”) the mouse device 502, and/or performing any other mouse input signal generation actions known in the art) that is detected by the port management engine 204 using the disabled port protocol 700 and via the host controller(s) 208 and the port 210b.

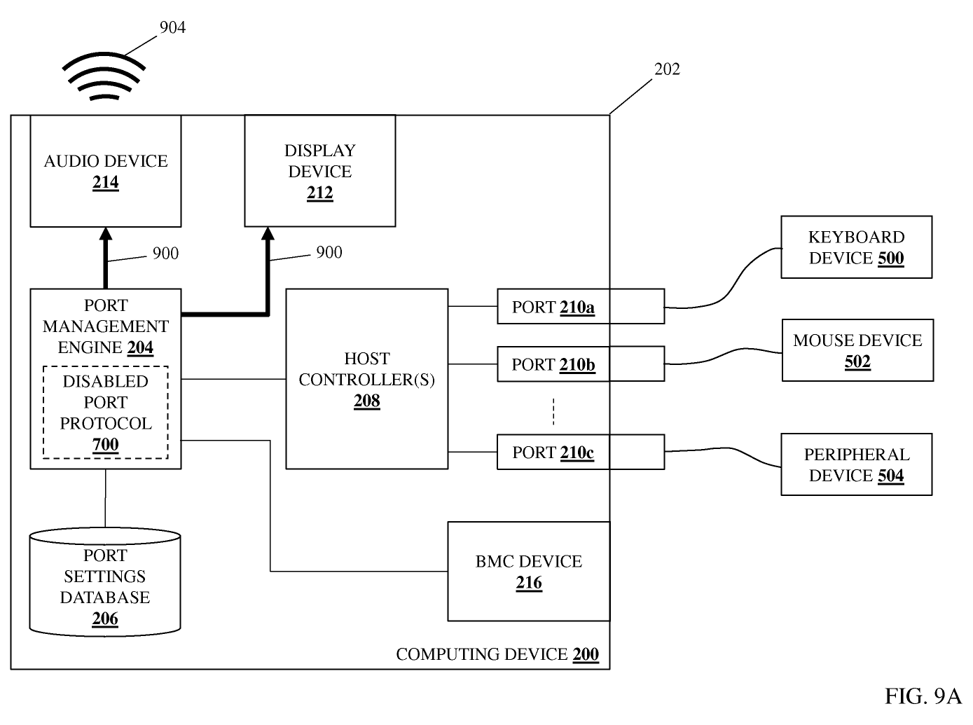

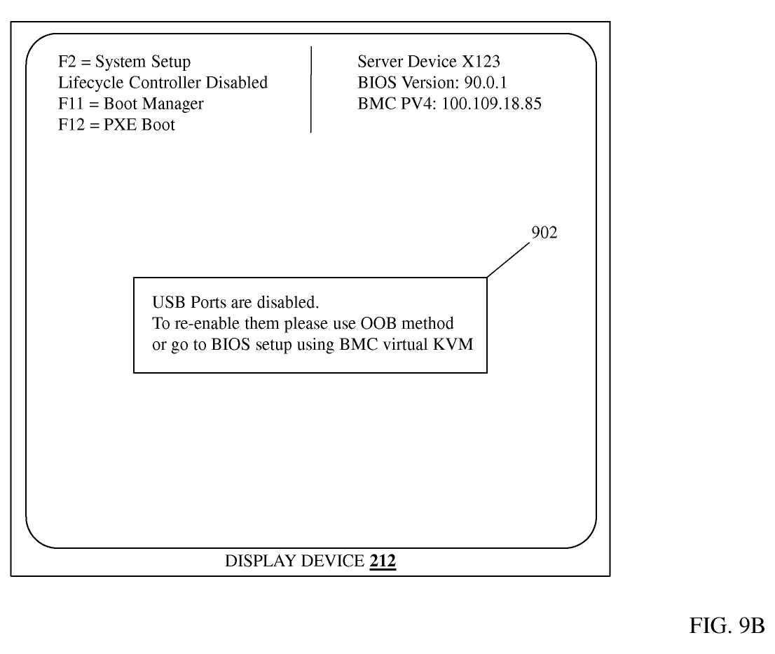

With reference to FIG. 9A, in an embodiment of block 314, the port management engine 204 may use the disabled port protocol 700 to perform disabled port support alert provisioning operations 900 that may include generating a disabled port support alert message that identifies that the port was disabled to provide the disabled port, that includes instructions for enabling the disabled port, and/or that may include any other disabled port support information that would be apparent to one of skill in the art in possession of the present disclosure, and then providing that disabled port support alert message for display on the display device 212. To provide a specific example, FIG. 9B illustrates an embodiment of the display device 212 displaying a disabled port support alert message 902 that identifies that “USB ports are disabled” on the computing device 200, and includes instructions “To re-enable them please use OOB method or go to BIOS setup using BMC virtual KVM” (i.e., a BMC virtual KVM available via the BMC device 216 as described above), although one of skill in the art in possession of the present disclosure will appreciate how any of a variety of disabled port support alert messages (e.g., an instruction to install a physical jumper device to clear out current BIOS settings and enable default BIOS settings that will enable the port(s)) will fall within the scope of the present disclosure.

FIG. 9A also illustrates how the port management engine 204 may use the disabled port protocol 700 to perform disabled port support alert provisioning operations 900 that may include activating the audio device 214 to produce disabled port support alert audio (as illustrated by element 904 in FIG. 9A). As such, in some examples the disabled port support alert may be provided by the display of the disabled port support message along with the disabled port support alert audio. However, one of skill in the art in possession of the present disclosure will appreciate how either the of the disabled port support message or the disabled port support alert audio may be provided at block 314 while remaining within the scope of the present disclosure as well. Furthermore, while two specific examples of disabled port support alerts have been provided, one of skill in the art in possession of the present disclosure will appreciate how other disabled port supports alerts will fall within the scope of the present disclosure as well.

If at decision block 312 an input signal is not generated by the HID connected to the disabled port, or following block 314, the method 300 proceeds to decision block 316 where the method 300 proceeds depending on whether the computing device is initialized. Similarly as described above, the initialization of the computing device 200 may continue while the port management engine 204 monitors for the connection of an HID to a disabled port and provides disabled port support alert(s) when any input signals are generated by any HID connected to a disabled port, and will eventually complete such that an operating system is loaded on the computing device 200 and the computing device 200 enters runtime as described below. If, at decision block 316, the computing device is not initialized, the method 300 returns to decision block 312. As such, the method 300 may loop such that the port management engine 204 continues to monitor for the connection of an HID to a disabled port, and provides disabled port support alert(s) when any input signals are generated by any HID connected to a disabled port, until the initialization of the computing device 200 is completed. If at decision block 316 the computing device is initialized, the method 300 proceeds to block 308 where the computing device enters runtime as described above.

As will be appreciated by one of skill in the art in possession of the present disclosure, many computing devices ignore input signals from mouse devices during their initialization, or require an input signal from a keyboard device (e.g., selection of an “F2” key on the keyboard device) in order to enable the computing device to receive input signals from the mouse device during computing device boot/initialization. As such, many embodiments of the present disclosure may only perform the detection of a keyboard device connected to a disabled port, the corresponding enablement of the disabled port support protocol for that keyboard device, and the use of that disabled port support protocol to detect input signals from that keyboard device and provide corresponding disabled port support alerts. However, embodiments of the present disclosure in which only the detection of a mouse device connected to a disabled port, the corresponding enablement of the disabled port support protocol for that mouse device, and the use of that disabled port support protocol to detect input signals from that mouse device and provide corresponding disabled port support alerts will fall within the scope of the present disclosure as well.

Thus, systems and methods have been described that enable a disabled port support protocol when a human interface device is connected to a disabled port in order to provide for the detection of an input signal from that human interface device so that a disabled port support alert may be provided. For example, the disabled port support system of the present disclosure may include a computing device including a port. A port management subsystem in the computing device is coupled to the port. During initialization of the computing device, the port management subsystem determines that the port is configured to be disabled to provide a disabled port. When the port management subsystem detects that a human interface device has been connected to the disabled port, it enables a disabled port support protocol for the human interface device that is connected to the disabled port. The port management subsystem may then use the disabled port support protocol to detect if an input signal has been generated by the human interface device that is connected to the disabled port and, if so, provide a disabled port support alert. As discussed below, a user wishing to enabled ports that have been disabled on a computing device may connect a human interface device to that computing device and use it to provide an input signal that results in a disabled port support alert message, disabled port support alert audio, and or other disabled port support alerts that would be apparent to one of skill in the art in possession of the present disclosure, thus reducing customer support calls related to inabilities to enable disabled ports and the expenditure of resources in order to address them.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A disabled port support system, comprising:
a computing device;
a port that is included on the computing device; and
a port management subsystem that is included in the computing device, coupled to the port, and configured, during initialization of the computing device, to:
determine that the port is configured to be disabled to provide a disabled port;
detect that a human interface device has been connected to the disabled port;
enable a disabled port support protocol for the human interface device that is connected to the disabled port;
detect, using the disabled port support protocol, an input signal generated by the human interface device that is connected to the disabled port; and
provide, in response to detecting the input signal generated by the human interface device that is connected to the disabled port using the disabled port support protocol, a disabled port support alert.

2. The system of claim 1, wherein the port management subsystem is provided by a Basic Input/Output System (BIOS) for the computing device.

3. The system of claim 1, wherein the human interface device is a keyboard device and the input signal is generated by the keyboard device in response to selection of a key on the keyboard device.

4. The system of claim 3, wherein the port management subsystem is configured to:
prevent the installation of a simple text input protocol and a simple text output protocol following the detection of the human interface device to the disabled port.

5. The system of claim 1, wherein the port is a Universal Serial Bus (USB) port such that the disabled port is a disabled USB port.

6. The system of claim 1, wherein the providing the disabled port support alert includes:
displaying a disabled port support alert message that identifies that the port was disabled to provide the disabled port, and that includes instructions for enabling the disabled port.

7. An Information Handling System (IHS), comprising:
a processing system; and
a memory system that is coupled to the processing system and that includes instructions that, when executed by the processing system, cause the processing system to provide a port management engine that is configured, during Information Handling System (IHS) initialization operations, to:
determine that a port that is coupled to the processing system is configured to be disabled to provide a disabled port;
detect that a human interface device has been connected to the disabled port;
enable a disabled port support protocol for the human interface device that is connected to the disabled port;
detect, using the disabled port support protocol, an input signal generated by the human interface device that is connected to the disabled port; and
provide, in response to detecting the input signal generated by the human interface device that is connected to the disabled port using the disabled port support protocol, a disabled port support alert.

8. The IHS of claim 7, wherein the port management engine is provided by a Basic Input/Output System (BIOS).

9. The IHS of claim 7, wherein the human interface device is a keyboard device and the input signal is generated by the keyboard device in response to selection of a key on the keyboard device.

10. The IHS of claim 9, wherein the port management engine is configured to:
prevent the installation of a simple text input protocol and a simple text output protocol following the detection of the human interface device to the disabled port.

11. The IHS of claim 7, wherein the port is a Universal Serial Bus (USB) port such that the disabled port is a disabled USB port.

12. The IHS of claim 7, wherein the providing the disabled port support alert includes:
displaying a disabled port support alert message that identifies that the port was disabled to provide the disabled port, and that includes instructions for enabling the disabled port.

13. The IHS of claim 7, wherein the providing the disabled port support alert includes:
activating an audio device to produce disabled port support alert audio.

14. A method for providing disabled port support, comprising:
determining, by a port management subsystem during initialization of a computing device, that a port is configured to be disabled to provide a disabled port;
detecting, by the port management subsystem during the initialization of the computing device, that a human interface device has been connected to the disabled port;
enabling, by the port management subsystem during the initialization of the computing device, a disabled port support protocol for the human interface device that is connected to the disabled port;
detecting, by the port management subsystem during the initialization of the computing device using the disabled port support protocol, an input signal generated by the human interface device that is connected to the disabled port; and
providing, by the port management subsystem during the initialization of the computing device in response to detecting the input signal generated by the human interface device that is connected to the disabled port using the disabled port support protocol, a disabled port support alert.

15. The method of claim 14, wherein the port management subsystem is provided by a Basic Input/Output System (BIOS).

16. The method of claim 14, wherein the human interface device is a keyboard device and the input signal is generated by the keyboard device in response to selection of a key on the keyboard device.

17. The method of claim 16, further comprising:
preventing, by the port management subsystem, the installation of a simple text input protocol and a simple text output protocol following the detection of the human interface device to the disabled port.

18. The method of claim 14, wherein the port is a Universal Serial Bus (USB) port such that the disabled port is a disabled USB port.

19. The method of claim 14, wherein the providing the disabled port support alert includes:
displaying a disabled port support alert message that identifies that the port was disabled to provide the disabled port, and that includes instructions for enabling the disabled port.

20. The method of claim 14, wherein the providing the disabled port support alert includes:
activating an audio device to produce disabled port support alert audio.
